(19) United States
(12) Patent Application Publication
(10) Pub. No.: US 2022/0384838 A1
(43) Pub. Date: Dec. 1, 2022

(54) BATTERY MODULE FOR A TRACTION BATTERY OF AN ELECTRIC VEHICLE

(71) Applicant: Lisa Draexlmaier GmbH, Vilsbiburg (DE)

(72) Inventors: Peter Wagner, Karlsfeld (DE); Benjamin Bardosch, Landshut (DE); Michael Flieser, Geisenhausen (DE); Alexander Hahn, Roettenbach (DE); Robert Magunia, Geisenhausen (DE); Thomas Sperl, Landau an der Isar (DE)

(21) Appl. No.: 17/750,447

(22) Filed: May 23, 2022

(30) Foreign Application Priority Data
May 25, 2021 (DE) 10 2021 113 419.6

(51) Int. Cl. H01M 10/04; H01M 50/242; H01M 50/207; H01M 50/249; H01M 50/224

(52) U.S. Cl. CPC H01M 10/0468; H01M 50/242; H01M 50/207; H01M 50/249; H01M 50/224

(57) ABSTRACT

A battery module for a traction battery of an electric vehicle is described. The battery module has two side parts arranged on opposite sides of the battery module and aligned substantially parallel to an electrode surface of cells of the battery module. At least one of the side parts has an elastic region offset from a main extension plane of the side part. The elastic region is adapted to exert a pressing force perpendicular to the electrode surface on the cells.

### CROSS REFERENCE TO RELATED APPLICATIONS

This application claims priority to German Patent Application 102021113419.6, filed on May 25, 2021, the content of which is herein incorporated by reference

### BACKGROUND OF THE INVENTION

### Field of the Invention

The present invention relates to a battery module for a traction battery of an electric vehicle.

### Description of Related Art

The present invention is described below primarily in connection with traction batteries for electric vehicles. However, the invention can be used in any accumulator in which large amounts of energy are to be supplied or dissipated.

A traction battery of an electric vehicle is configured to store electrical energy for driving the electric vehicle with automotive high voltage, to be discharged during operation for high current acceleration operations, and to be charged for high current electrical braking operations.

Cells of the traction battery can be combined in battery modules. The traction battery can have several battery modules. The battery modules can each have a housing.

During charging and discharging, the cells can change their volume or thickness. Since the traction battery and the battery modules have fixed external dimensions, compressible plates can be arranged between the housings of the battery modules and the cells, which can be compressed when the cells expand.

### BRIEF SUMMARY OF THE INVENTION

One task of the present invention is therefore to provide an improved battery module for a traction battery of an electric vehicle using means that are relatively simple in design.

An improvement in this respect can relate, for example, to improved expansion compensation, and in particular uniform pressure distribution.

In battery cells, charging and discharging processes can cause a change in volume. In prismatic cells or pouch cells, the change in volume causes a change in thickness perpendicular to an electrode surface of the cells. Since several battery cells are arranged next to or on top of each other in a battery module perpendicular to the electrode surface or their flat sides, their thickness changes add up. However, the external dimensions of the battery module are specified by design and should not be exceeded.

In the approach presented here, a housing of the battery module is designed in such a way that at least one of the side surfaces, bottom surface and/or top surface of the housing aligned parallel to the electrode surface has at least one elastically deformable area which can be displaced outwards like a spring by a force resulting from an increase in thickness of the cells and which is displaced back again by a restoring force when the thickness of the cells is reduced. The area can be a side surface, floor surface or ceiling surface of the battery module.

In an unloaded state, the elastic region is offset relative to a plane of the surface at least proportionally in the direction of an inner side of the module. The elastic area is integrally connected to a rigid area of the surface. The rigid area is arranged in particular in the plane.

A battery module for a traction battery of an electric vehicle is proposed, the battery module having two side members disposed on opposite sides of the battery module and aligned substantially parallel to an electrode surface of cells of the battery module, at least one of the side members having an elastic region adapted to exert a pressing force perpendicular to the electrode surface on the cells.

A traction battery can be understood as an energy storage device for an electrically driven vehicle. The traction battery can have a housing that encloses components of the traction battery and protects them from mechanical influences and environmental influences. The traction battery may have a modular design. For example, the traction battery may be attached to a floor assembly of the vehicle. The housing may have internal stiffening elements. The stiffening elements can specify an available installation space for battery modules of the traction battery.

The traction battery can have several battery modules. The battery modules can be arranged between the stiffening elements of the traction battery. A battery module can combine several cells or battery cells. The cells may be electrically interconnected within the battery module. The battery modules may be electrically interconnected within the traction battery. The battery module may include a housing that encloses the cells. The housing may have a substantially cuboidal basic shape.

The cells can be prismatic cells or pouch cells in particular. Different materials can be arranged in layers in the cells. The layers can be planar, and each arranged in parallel planes. Electrodes of the cells may be adjacent to the layers. The electrodes may be, for example, metal sheets. The electrodes may likewise be arranged parallel to the planes. An electrode surface may correspond to a flat side of the electrode. The electrode surface may be substantially parallel to a surface of the cuboidal base shape.

A side part may be a component of the housing of the battery module. The side portion may form a surface of the basic cuboidal shape. The side portion may be oriented substantially parallel to the electrode surface. The face of the cuboidal base shape may lie in the main plane of extension of the side portion.

An elastic region may be a resilient region. The elastic region may have a spring characteristic defined by a geometry of the elastic region. The spring characteristic may be linear or nonlinear. For example, the spring characteristic may be progressive. The elastic region may have a higher elasticity and therefore be displaceable with lower forces in a direction orthogonal to the main extension plane of the side member than is true for the side member in its entirety. In other words, in addition to the elastic region, the side part may also have at least one stiffening support region with a lower elasticity.

The elastic area can be arranged offset to a main extension plane of the side part. In particular, the elastic region can be arranged offset from the main extension plane in the direction of a module interior.

In the assembled state, the elastic section can be preloaded to exert a minimum pressing force on the cells. The pressing force can increase depending on the spring characteristic and a deflection of the elastic area.

The side panel may be embossed or deep-drawn. Likewise, a three-dimensional structure may be otherwise formed. The elastic region may have been issued from the main extension plane by an embossing process or a deep-drawing process. Similarly, rigid support regions of the side member may be produced by the embossing process or the deep drawing process. Stiffeners of the support areas may also be bent in the direction of the module interior.

The side panel can be made of a metal material. A metal material can have good elastic properties and high thermal conductivity. The metal material can be well stamped or deep-drawn. The side part can be made of a material containing iron and/or aluminum. The stiff and elastic areas can be formed by different materials or material combinations or material distributions. Alternatively, the side part may be made of a plastic material. The plastic material can likewise be deep drawn. Alternatively, the plastic material may be injection molded.

The pressing force can correspond to a surface pressure between 1 kPa and 10 kPa, i.e. between 0.01 bar and 0.1 bar. The resulting pressing force depends on an area of the cells. The larger the cells, the higher the pressing force required to achieve the desired surface pressure.

The side member may have at least one recess between the elastic region and a support region disposed in the main extension plane. A recess may be referred to as a cut or aperture. A recess may reduce a stiffness of the elastic region. The recess may extend along an entire side length of the elastic region. For example, the elastic region may be a tongue-shaped spring element. The spring element may be separated from the support area by recesses on one, two or three sides.

At least one distributor plate can be arranged between the elastic region and an outermost of the cells accommodated in the battery module. The distribution plate can distribute the pressing force evenly. The distribution plate may also insulate and/or protect. A distribution plate may increase an area of application of the pressing force. The distribution plate may be substantially as large as the cells, i.e., have an area as large as that flat side of the outermost cell against which the distribution plate abuts. The distributor plate can distribute the pressing force over the entire flat side of the cell. For this purpose, the distributor plate or a supporting structure of the distributor plate can have a higher stiffness or lower elasticity than the elastic area of the side part. The distributor plate can be arranged so that it can move relative to the side part.

The manifold plate may have a metal sheet. The metal sheet can have a high thermal conductivity. The manifold plate can transfer heat from the adjacent cell directly to the side panel.

The manifold plate may have a layer of compressible material. The compressible material can be referred to as a compression pad. The compressible material can compensate for small-scale thickness tolerances of the outermost cell and provide uniform surface pressure. The compressible material may have a higher compressibility than a material of the supporting structure of the distribution plate.

The elastic area may be divided into several separate sub-areas. In other words, the side part can have several separate elastic areas. Each sub-area can act as an independent spring. Multiple sub-regions make it easy to compensate for uneven thickness variations. Multiple sub-regions allow the pressing force to be evenly distributed.

The sub-ranges can be of the same type. The partial areas can all have the same spring characteristic. In this way, a particularly uniform distribution of the pressing force can be achieved.

The side part can have flexurally rigid support areas along at least two opposite edges. In particular, the side part can have support areas along a top edge and a bottom edge. The support regions may reduce deflection of the side member due to the pressing force. The support regions may have ribs bent substantially perpendicular to the main extension plane to provide high bending resistance.

The side part can have a flexurally rigid support area between each of the sub-areas of the elastic area. The support areas between the elastic areas can be arranged transversely to the support areas at the edges. The support areas can be arranged in the form of a ladder.

The side parts may be connected to each other by at least one web. A web can be a strip of a metal material that is mechanically connected to both side parts. For example, the web can be snapped into corresponding recesses in the side parts. The web prevents buckling of the side parts due to the applied pressing force by supporting the counterforce to the pressing force on the respective opposite side part.

### BRIEF DESCRIPTION OF THE SEVERAL VIEWS OF THE DRAWING

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

An advantageous embodiment of the present invention is set out below with reference to the accompanying figures, wherein:

FIG. 1 depicts a representation of a battery module according to an embodiment example;

FIG. 2 depicts a sectional view of a battery module according to an embodiment; and

FIG. 3 depicts an illustration of a battery module according to an embodiment.

The figures are merely schematic representations and serve only to explain the invention. Identical or similarly acting elements are marked throughout with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of” A, B, and C” should be understood as including only one of A, only one of B, only one of C, or any combination of A, B, and C.

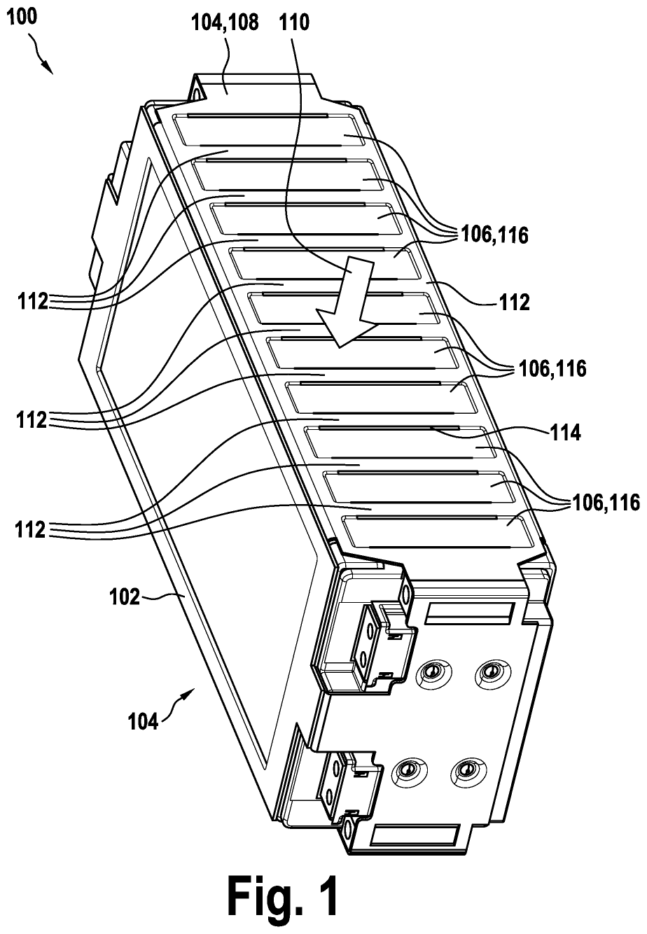

FIG. 1 depicts an illustration of a battery module 100 according to an embodiment of the present invention. The battery module 100 may be interconnected with a plurality of other battery modules 100 to form a traction battery of an electric vehicle. The battery module 100 includes a housing 102 that encloses a plurality of flat side to flat side battery cells, or cells for short, of the battery module 100. The cells may be pouch cells or prismatic cells. Electrodes of the cells are arranged parallel to the flat sides. The cells are electrically connected within the housing between two terminals of the battery module 100. Here, the cells are arranged side by side in the housing 102.

The housing 102 is approximately cuboidal in shape. Two opposing side portions 104 of the housing 102 are oriented substantially parallel to the flat sides of the cells and electrode surfaces of the electrodes, respectively.

When the cells are charged or discharged, their volume may change. In particular, the volume change affects a thickness of the individual cell. The changes in the thickness of all cells of the battery module 100 may add up.

To compensate for this change in thickness, at least one of the side members 104 includes an elastic region 106. The elastic region 106 acts as a mechanical spring and compensates for the change in thickness of the cells. The elastic region 106 is arranged inwardly offset from a main extension plane 108 of the side member 104 to provide a defined spring travel. The elastic region 106 can be deformed to a maximum of the main extension plane 108. That is, an offset between the elastic region 106 and the main extension plane 108 defined, for example, by support regions 112 is preferably greater than or equal to the spring travel by which the elastic region 106 elastically displaces under normal operating conditions. For example, the displacement in a direction perpendicular to the main extension plane 108 may be more than 1 mm, such as for example several millimeters.

The elastic region 106 has a spring characteristic. A pressing force 110 of the elastic area 106 depends on the spring characteristic and a deformation of the elastic area 106. The spring characteristic depends on material properties of the side part 104 and a geometric design of the elastic area 106. For an advantageous spring characteristic, the side part 104 consists in particular of a metal material or metal sheet. The pressing force 110 acts perpendicularly on the flat side of the outermost cell. The pressing force 110 presses all cells of the battery module 100 together. The pressing force 110 is variable and becomes greater when the thickness of the cells increases, as the deformation of the elastic region 106 increases. When the thickness of the cells decreases, the pressing force 110 becomes smaller as the deformation decreases.

In one embodiment, the elastic region 106 is embossed or deep-drawn into the side part 104. During the embossing or deep-drawing process, the side part is permanently plastically deformed and the elastic region 106 is formed as a depression or pocket in the side part 104.

In one embodiment, the side member 104 includes at least one recess 114 between support regions 112 of the side member 104 and the elastic region 106. The recess 114 is a slot or opening in the side member 104. The recess 114 allows the spring characteristic of the elastic region 106 to be adjusted as required. In particular, the recess 114 makes the elastic region 106 less stiff. In other words, the elastic region 106 can be selectively weakened by the recess 114 to reduce the pressing force 110. For example, the pressing force 110 can be limited such that a surface pressure of the cells between 0.01 bar and 0.1 bar results.

In one embodiment, the elastic region 106 is divided into a plurality of subregions 116. A support region 112 is disposed between each two subregions 116. The support regions 112 are arranged substantially in the main extension plane 108. The support regions 112 are configured here in a ladder-like manner, wherein two outer support regions 112 extending along opposite longitudinal edges of the side portion 104 represent uprights of a ladder and support regions 112 extending transversely between the outer support regions 112 represent rungs of the ladder. The sub-regions 116 of the resilient region 106 are thus enclosed by the rungs and stiles. The sub-regions 116 may be substantially similar.

In one embodiment, the support portions 112 extending along the edges are stiffened by three-dimensional deformations of the side portion 104. In this regard, the deformations are folded regions of the side portion 104 substantially perpendicular to the main extension plane 108. The folded regions thus extend substantially parallel to a cover of the battery module 100.

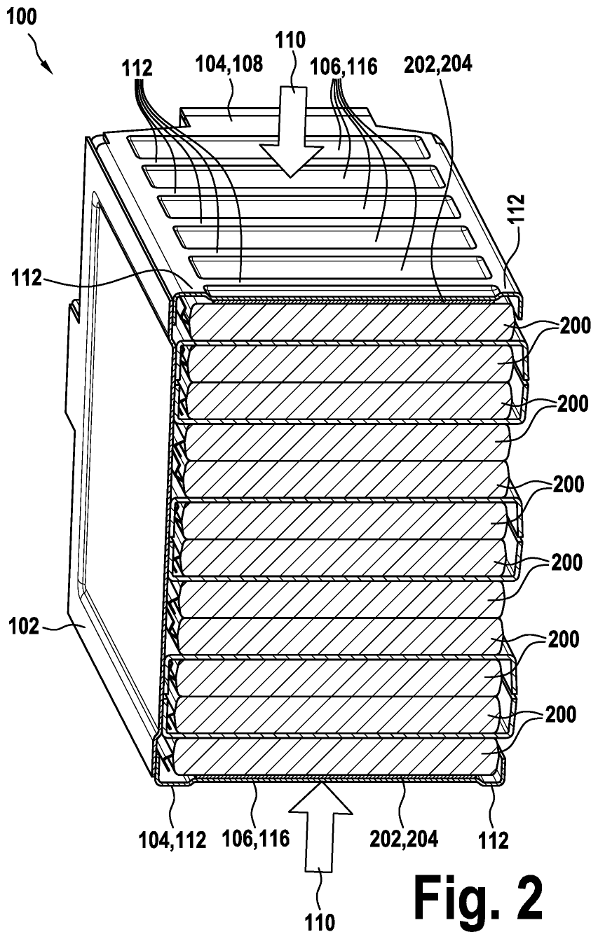

FIG. 2 depicts a sectional view of a battery module 100 according to an embodiment. The battery module 100 corresponding substantially to the battery module in FIG. 1 is shown cut perpendicular to the main extension plane 108. The battery module 100 has 12 cells 200. Here, the cells 200 are pouch cells. In this embodiment example, both side portions 104 have elastic regions 106.

In one embodiment, distributor plates 202 are arranged between the outermost cells 200 and the elastic regions 106 for even distribution of the pressing force 110. The distribution plates 202 may be, for example, flat metal sheets that provide good heat dissipation due to their high thermal conductivity. The distributor plates 202 may also comprise a compressible material 204. In particular, the compressible material 204 may directly contact the outer cells 200 and compensate for flatness tolerances of the cells 200 and the manifold plates 202. The compressible material 204 may also be compressed or relieved by the change in thickness of the cells 200.

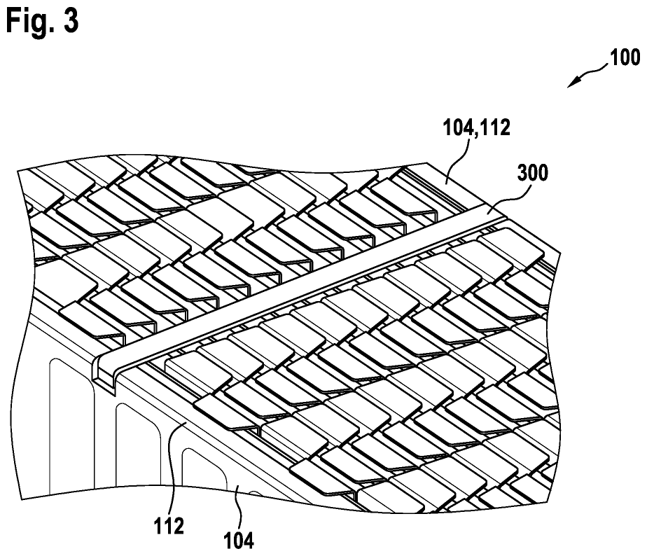

FIG. 3 depicts an illustration of a battery module 100 according to an embodiment. The battery module 100 is substantially similar to the battery modules shown previously. In addition, here the side portions 104 arranged on opposite sides of the battery module 100 are connected to each other by a web 300 loaded in tension. The web 300 transmits at least a portion of the counterforce to the pressing force 110 of one side part 104 to the respective other side part 104. The web 300 is connected to the respective side part 104 in the region of the support region 112 extending along the respective side part 104. The web 300 approximately prevents outward deformation of the support areas 112.

Here, the web 300 is arranged on a bottom side of the battery module 100. Similarly, at least one other web may be arranged on an upper side of the battery module 100. For example, the webs may each be arranged centrally on the side portions 104.

In an alternative embodiment, the side portions 104 are supported by at least one band extending around the entire battery module 100. The band extends in a closed annular manner over the top side, the bottom side and the side parts 104. For example, a bead for the band may be provided in the side parts.

In other words, a module housing with swelling compensation is presented.

Lithium pouch cells exhibit a reversible change in thickness perpendicular to the electrode surface during charging and discharging (cyclization). Furthermore, pouch cells require a minimum pressure of the electrodes so that the electrode stack can be reset during recurring cyclization and no delamination of the electrodes to each other takes place. If pouch cells are assembled to form a cell module, compensating elements can be provided to ensure a minimum pressing force over the electrode surface. For example, the module frame can conventionally be designed to be as rigid as possible and thickness compensation can be achieved using elastic insertion mats. However, this requires high pretensioning forces and uniform surface pressure is difficult to achieve.

In the approach presented here, the pressing sides of the module frame are designed in such a way that they are elastically prestressed to ensure uniform surface pressure over the operating time of the module.

The approach presented here can achieve weight savings in the module frame, reduced complexity by eliminating additional balancing elements, and simplification of the module design.

The cell module with lithium pouch cells for a vehicle battery presented here has preformed side parts which exert a homogeneous pressing force perpendicular to the electrode surfaces. The side parts have elastic areas that allow thickness changes of the cells and permanently ensure homogeneous surface pressure. The side parts consist of stamped or deep-drawn metal sheets. In conjunction with a minimum pressing force, the embossing exhibits a uniform bending curve which exerts uniform surface pressure. The bending stiffness of the side parts can be adjusted by recesses. For example, the initial pressing force on each cell area can be set between 0.01 bar and 0.1 bar.

The side parts can additionally be connected at least once along their length by an elastic web or other mechanical connection to reduce outward deflection of the support areas. The web or connection can be designed, for example, as a metal clip or encircling band. The connection can be arranged on an upper side and/or lower side of the battery module.

Since the devices and methods described in detail above are examples of embodiments, they can be modified to a wide extent by the skilled person in the usual manner without leaving the scope of the invention. In particular, the mechanical arrangements and the proportions of the individual elements with respect to each other are merely exemplary. Some preferred embodiments of apparatus according to the invention have been disclosed above. The invention is not limited to the solutions explained above, but the innovative solutions can be applied in different ways within the limits set by the claims.

What is claimed is:

1. A battery module for a traction battery of an electric vehicle, the battery module comprising:
two side members arranged on opposite sides of the battery module and oriented substantially parallel to an electrode surface of cells of the battery module, and
wherein at least one side member comprises a resilient portion configured to exert a pressing force perpendicular to the electrode surface on the cells.

2. The battery module according to claim 1, wherein the elastic portion is offset from a main extension plane of the side member.

3. A battery module according to claim 1, wherein the side member comprises a metal material.

4. The battery module according to claim 1, wherein the pressing force corresponds to a surface pressure between 1 kPa and 10 kPa.

5. The battery module according to claim 1, wherein the side member comprises at least one recess arranged between the elastic region and a support region disposed in the main extension plane.

6. The battery module according to claim 1, wherein at least one distribution plate is arranged between the elastic region and an outermost cell.

7. The battery module according to claim 6, wherein the manifold plate comprises a metal sheet.

8. The battery module according to claim 6, wherein the manifold plate comprises a layer of a compressible material having a higher compressibility than a material of a supporting structure of the manifold plate.

9. The battery module according to claim 1, wherein the elastic region comprises a plurality of separate subregions.

10. The battery module according to claim 9, wherein the subregions are of the same type.

11. The battery module according to claim 1, wherein the side member comprises flexurally rigid support portions arranged along at least two opposing edges.

12. The battery module according to claim 9, wherein the side member comprises a flexurally rigid support region arranged between each of the subregions.

13. The battery module according to claim 1, wherein the side portions are interconnected by at least one web.
